(19) United States
(12) Patent Application Publication
(10) Pub. No.: US 2003/0212585 A1
(43) Pub. Date: Nov. 13, 2003

(54) Idea drawing support method and program product therefor

(75) Inventors: Yuji Kyoya, Kanagawa-Ken (JP); Kunio Noguchi, Kanagawa-Ken (JP); Takashi Nakano, Kanagawa-Ken (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/431,527

(22) Filed: May 8, 2003

(30) Foreign Application Priority Data
May 9, 2002 (JP) 2002-133463

(51) Int. Cl. G06F 17/60

(52) U.S. Cl. 705/7

(57) ABSTRACT

Provided are a computer-aided idea-drawing support method and a program product for supporting idea drawing that achieve effective VOC-based idea drawing and classification. A data file, a collection of VOCs, is loaded to display a classification window containing a group window and several item (contents-view) windows. A specific operation to an item displayed on one of the item windows displays a next-level-item extraction window on the classification window for a next-level-item extraction procedure. On-screen item and/or group handlings cause classification procedures, such as, change in group to which an item belongs, displaying group contents and change in group hierarchy. Results of extraction and classification procedures are stored as history.

### CROSS REFERENCE TO RELATED APPLICATIONS

This application is based upon and claims benefit of priority from the prior Japanese Patent Application No. 2002-133463 filed on May 9, 2002 in Japan, the entire contents of which are incorporated by reference.

### BACKGROUND OF THE INVENTION

1. Field of Art

The present invention relates to a computer-aided idea-drawing support method for drawing further levels of ideas from already created ideas and a program product for achieving the idea-drawing support method.

2. Related Art

Customers' demands on products and services are drawn from voice of customers (VOC) in planning new products and services. Voice of customers is usually given through interviews and questionnaires. The contents filled in an open blank in a questionnaire is treated as VOC whereas gender, age, occupation, etc, also filled in are treated as attribute information added to VOC.

Drawing customers' demands from VOCs is finding out demands on quality of products and services. A demand on quality in simple expression (with no more than two demands) is called “required quality”.

It is usually difficult to directly convert a VOC into “required quality” with several limitations. Usually, drawn from a VOC firstly is an item called “required item” with no limitations. The item “required item” is then simply expressed to draw “required quality”.

Drawing customers' demands from a large number of VOCs could face many similar or identical VOCs and result in many similar or identical “required items” at high possibility. This drawing procedure therefore requires repetition of drawing similar or identical VOCs and “required items”, hence suffering from unproductive operations. In addition, it is difficult to grasp trends of entire VOCs in each drawing operation.

In order to avoid such problems, VOCs and/or “required items” may be classified in to groups with deletion of duplicates to grasp trends of entire data before the drawing procedure. The classification procedure, however, requires comparative analysis of VOCs and/or “required items”, thus causing a lot of trouble.

Not only drawing demands from VOCs, but also drawing further levels of ideas from already created ideas suffers from the same problems.

### SUMMARY OF THE INVENTION

In view of these problems, a purpose of the present invention is to provide a computer-aided idea-drawing support method and a program product for supporting idea drawing that achieve efficient VOC-based idea drawing and classification.

To fulfill the purpose, the present invention offers extraction windows for computer-aided idea drawings and also a classification window for computer-aided idea classification for efficient idea drawing and classification.

The classification window allows the user to display several groups thereon for efficient idea drawing and classification while checking all the groups at once.

Several important terms used in this specification are defined as follows:

The term “idea” is widely interpreted. It is a sentence having a certain meaning. It includes persons' opinions and demands extracted therefrom. Not only that, however, the term “idea” includes sentences in general having a variety of meanings.

The term “group” may be a set of one or more ideas.

The term “classification” may be widely interpreted. Not only classification to several groups, but also the term “classification” may be defined as organization of ideas classified into groups and the groups.

The term “element” may be defined as each of elements that constitute a group.

The term “element character string” is widely interpreted. It maybe defined as a character string expressing each element displayed on screen. It includes an idea character string and a group character string expressing a group name.

The term “person's opinion” may be defined as any opinion given through questionnaires or interviews. It includes voice of customers in the field of planning.

The term “result of idea drawing and classification” may be defined as results containing, such as, ideas given through an idea drawing procedure and attribute information added to each idea, and also results containing ideas given through any information processing to classify ideas. This term may be widely interpreted, as including not only final results given on the completion of idea drawing and classification procedures but also a result given at each stage of the idea drawing and classification procedures.

A first aspect of the present invention is a computer-aided idea-drawing support method comprising: supporting drawing different levels of ideas from at least one idea at a level of source of drawing on a drawing window displaying the idea; supporting classification of the ideas into groups on a classification window displaying the drawn ideas, contents-view windows for displaying a list of elements per group with element character strings each expressing one of the elements constituting each group being openable on the classification window; and storing at least one result of the idea drawing and classification.

A second aspect of the present invention is a computer-readable program product for supporting idea drawing comprising: a function of supporting drawing different levels of ideas from at least one idea at a level of source of drawing on a drawing window displaying the idea; a function of supporting classification of the ideas into groups on a classification window displaying the drawn ideas, contents-view windows for displaying a list of elements per group with element character strings each expressing one of the elements constituting each group being openable on the classification window; and a function of storing at least one result of the idea drawing and classification.

### BRIEF DESCRIPTION OF DRAWINGS

FIG. 1 is a flowchart showing an outline idea-drawing support procedure according to an embodiment of the present invention;

FIG. 2 is an illustration of a data file subjected to the idea-drawing support procedure shown in FIG. 1;

FIG. 3 is an illustration of a classification window used in the idea-drawing support procedure shown in FIG. 1;

FIG. 4 is an illustration of the classification window shown in FIG. 3 after a classification procedure;

FIG. 5 is an illustration of a VOC-based next-level-item extraction window displayed on the classification window in the idea-drawing support procedure shown in FIG. 1;

FIG. 6 is an illustration of a required-item (RI)-based next-level-item extraction window displayed on the classification window in the idea-drawing support procedure shown in FIG. 1;

FIG. 7 is a flowchart showing a drawing-procedure subroutine in the idea-drawing support procedure in FIG. 1;

FIG. 8 is an illustration of item processing on item windows displayed over the classification window shown in FIG. 4;

FIGS. 9A and 9B are flowcharts showing an item-processing subroutine in the idea-drawing support procedure in FIG. 1;

FIG. 10 is an illustration of group processing on a group window displayed on the classification window shown in FIG. 4;

FIG. 11 is a flowchart showing a group-processing subroutine in the idea-drawing support procedure in FIG. 1;

FIG. 12 is an illustration of a table screen displayed on the completion of the idea-drawing support procedure in FIG. 1;

FIG. 13 is an illustration of a tree-diagram screen displayed on the completion of the idea-drawing support procedure in FIG. 1;

FIG. 14 is an illustration of on-screen operations while no windows are being closed;

FIG. 15 is an illustration of on-screen operations with addition of rows and columns to item windows on a classification window shown in FIG. 14;

FIG. 16 is an illustration of on-screen operations in change of the number of item windows;

FIG. 17 is an illustration of on-screen operations in change of the number of item windows; and

FIG. 18 is an illustration of on-screen operations in rearrangements of item windows.

### DETAILED DESCRIPTION OF EMBODIMENT

An embodiment according to the present invention will be disclosed with reference to the attached drawings, although showing one aspect of the invention.

The present invention is achieved with, for example, software running on computer. The software controls the computer hardware to achieve the invention, known techniques being partly used if feasible.

The type and architecture of hardware and software and also the range of targets to be processed by the software to achieve the invention are modifiable.

A software program disclosed later is one form of the present invention.

[1. Outline of Idea-Drawing Support Procedure]

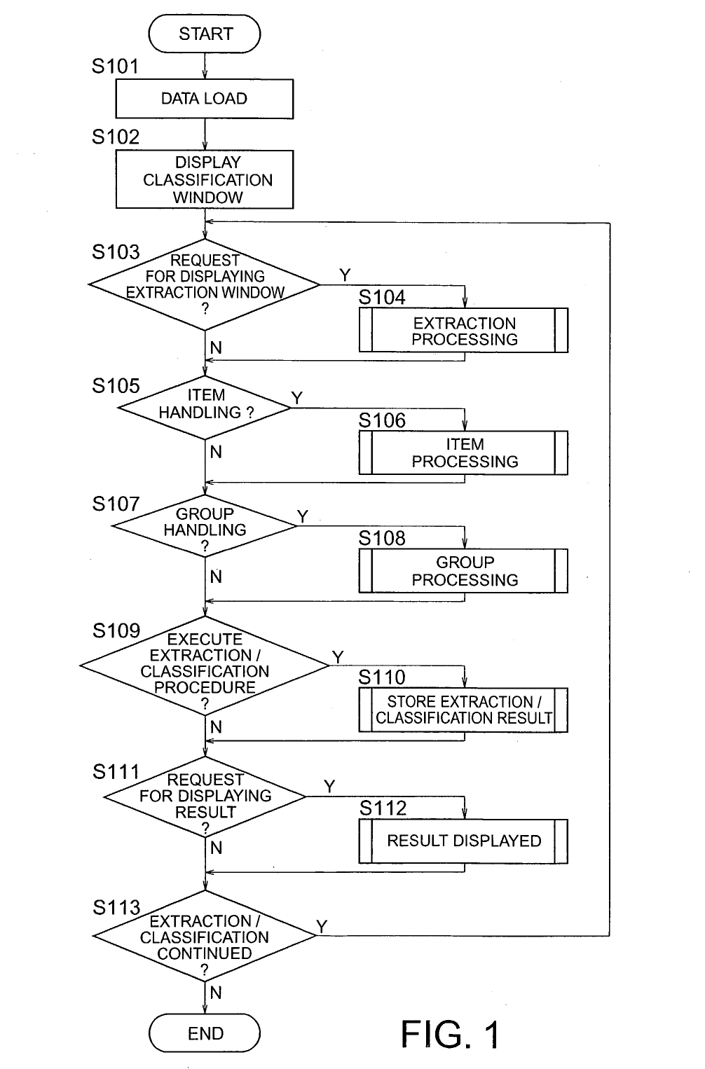

FIG. 1 is a flowchart showing an outline idea-drawing support procedure according to the present invention.

Disclosed here are extraction of “required items” and then “required qualities” from VOCs expressed in sentence and KJ-method-like or an affinity-diagram-method-like grouping at each of these levels. One idea expressed in sentence such as VOC, “required item” and “required quality” is handled as one item.

For brevity in the following disclosure, a character string expressing a group name is called a group or a group name in short. In addition, a character string expressing a VOC, a character string expressing a required item and a character string expressing a required quality are called a VOC or a VOC character string, a required item or a required-item character string, a required quality or a required-quality character string, respectively, in short.

The idea-drawing support procedure shown in FIG. 1 is disclosed in detail.

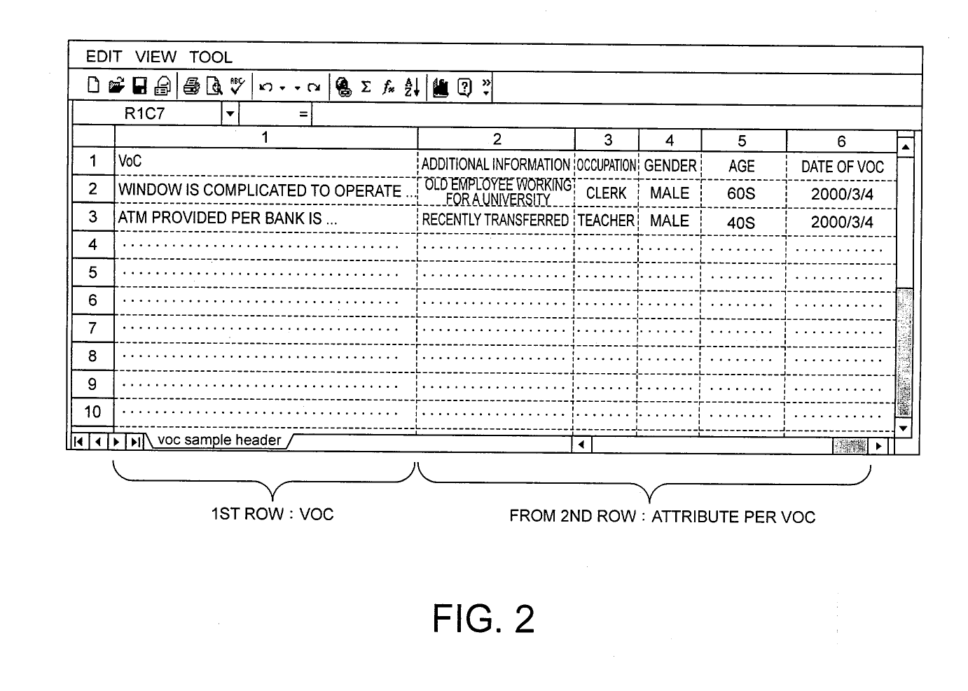

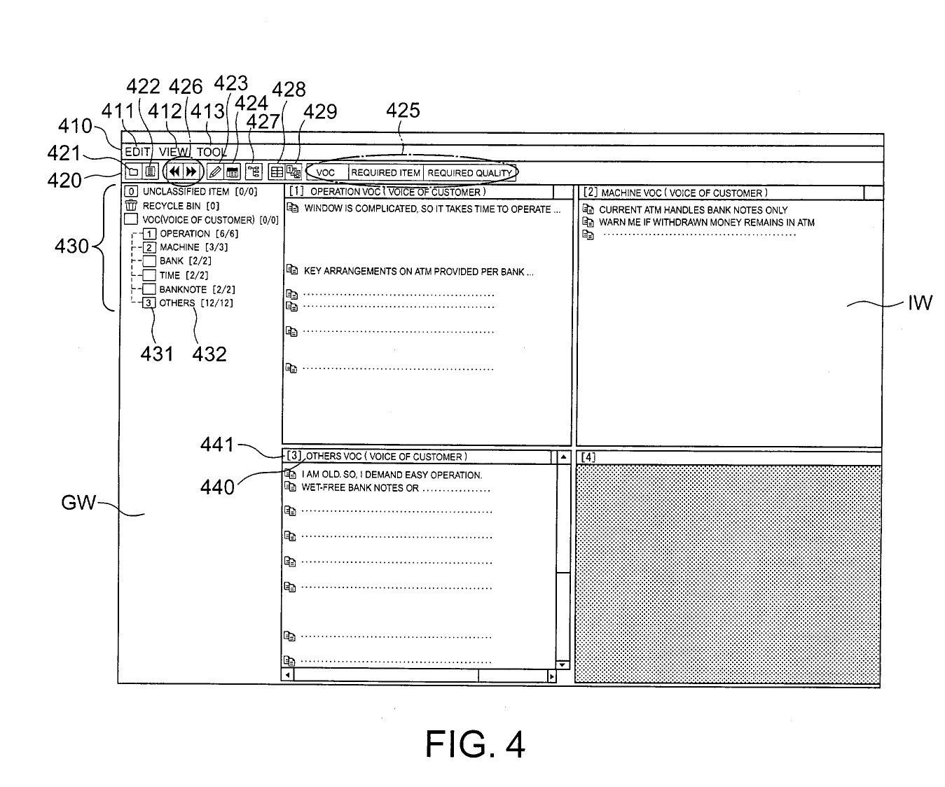

On a user operation such as data-file appointments, a data file, a collection of VOCs, such as shown in FIG. 2, is loaded into a computer work memory area (S101). Displayed on a computer screen is a classification window, or a subwindow, including a group window GW and several item (content-view) windows IWs (S102). The group window GW displays a group tree indicating a hierarchical group structure, using group names as shown in FIG. 4.

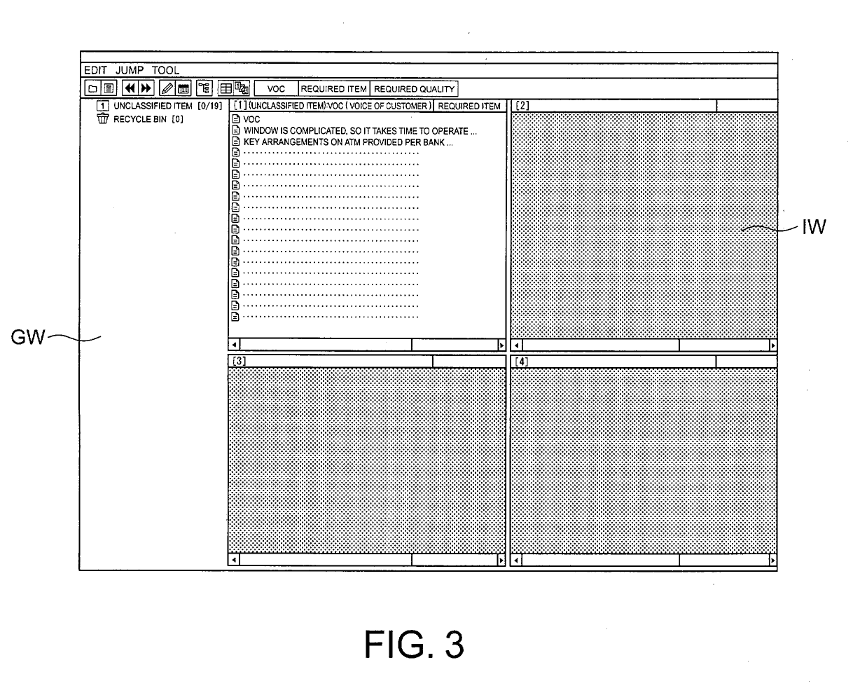

In this embodiment, as shown in FIG. 3, an item window is one of several (four in FIG. 3) windows displayed on the right side of a main screen. Each item window is also called a contents-view window. Further in this embodiment, as shown in FIG. 3, a group window is a single window displayed on the left side of the main screen. The group window displays a group tree.

For plain explanation of terms, a content-displaying state of an item window IW is called that a group is “open” or “opened”. In detail, an item window displays a list of group elements in the content-displaying state. When the display is brought into a halt, or an item window IW is in a content-closing state, it is called that a group is “closed”.

Moreover, when an item window is displaying the contents of a group, it is called that the item window is opened or being opened whereas it is not displaying the contents of a group, it is called that the item window is closed or being closed,

An item classification procedure is performed in accordance with user operations on the classification window shown in FIG. 3, such as, item classification and extraction of next-level items on a next-level-item extraction window, to reflect the user operation on data.

In detail, when a user selects an item displayed on any item window IW on the classification window to make a request for displaying a next-level-item extraction window (YES in S103), the next-level-item extraction window is displayed on the classification window for extraction of another item at the next level of the selected item (S104).

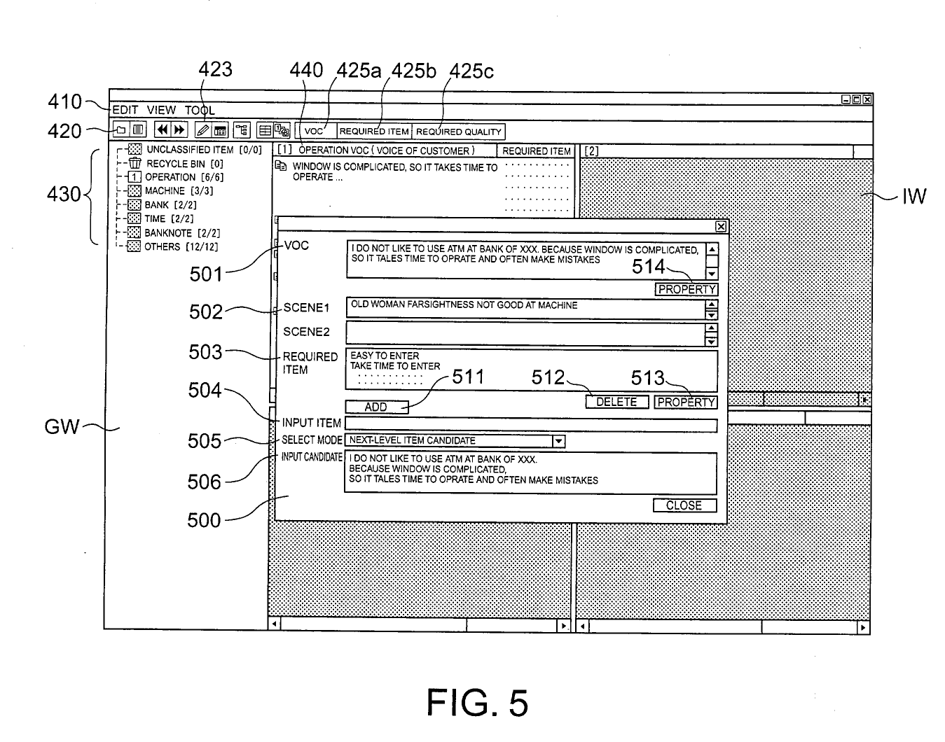

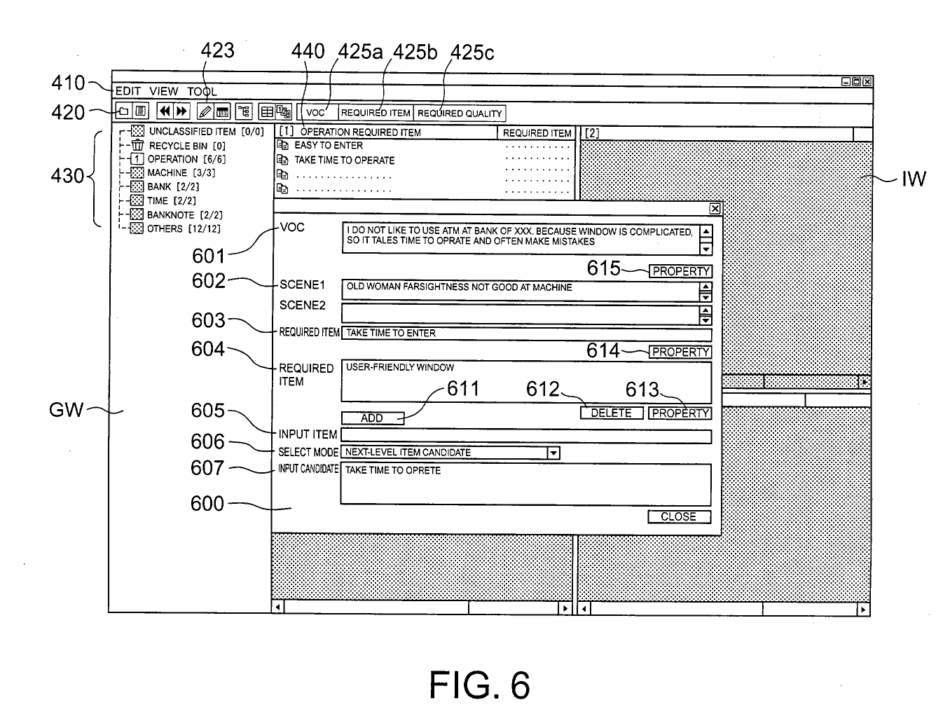

Displayed on the next-level-item extraction window are a current item, a next-level item entry blank, etc., as shown in FIGS. 5 and 6.

In detail, as shown in FIG. 5, a VOC, information added to the VOC, an extracted required item, etc., are displayed on a VOC-based next-level-item extraction window. In addition, displayed on a required-item(RI)-based next-level-item extraction window shown in FIG. 6 are a base VOC, or the source of extraction, attribute information added to the VOC, a required item, an extracted required quality, etc.

A user data entry operation on the next-level-item extraction window shown in FIG. 5 or 6 initiates processing of the entered data as a next-level item.

When a user performs an operation, such as, a shift operation to an item or a subgroup displayed on any item window IW in the classification window, except a request for opening the next-level-item extraction window (YES in S105), a classification procedure (item processing) is executed, for example, for changing the group to which the item or subgroup belongs (S106).

When the user shifts an item belonging to a group displayed on an item window IW to another group displayed on another opened item window IW, a data processing is executed to change the group to which the item has belonged to the new group.

In contrast, when the user shifts an item belonging to a group displayed on an item window IW to another group displayed on another closed item window IW, a data processing is executed to create a new group in the closed item window IW and change the group to which the item has belonged to the new group. The new group is temporarily given a group name composed of the entire character string of the item.

Contrary to this, when the user performs an operation such as a shift operation to any group displayed on the group window GW on the classification window (YES in step S107), a classification procedure (group processing) is executed to display the contents of the group, modification to the group hierarchy, etc (S108).

In detail, when the user double-clicks a group in a group tree displayed on the group window GW, the group is “opened” in a closed item window IW. It is “closed” when the user stops group appointments.

When the user shifts a group in a group tree displayed on the group window GW, a data processing is executed to modify the group hierarchy so that the group belongs to a new hierarchy level.

Next, when a user-desired extraction and classification procedure is executed (YES in step S109), the results of the procedure are reflected on the classification window and then stored in an extraction and classification history (step S110).

For example, when a required item is extracted as a next-level item on the VOC-based-next-level extraction window, the required item is stored. Or, when a new group is created by an item processing on an item window IW, the new group is displayed on the group window GW and data modified in accordance with the creation of new group is stored.

The extracted and classified data are stored automatically, with attribute information such as the time of extraction and classification, the name of an operator to create or modify the data.

The stored work data can be retrieved and used during the current extraction and classification procedure or another extraction and classification procedure.

Next, when the user requests that the results of classification be displayed on an operation menu or via an icon displayed on the classification window (YES in step S111), a result window is displayed in a specific format different from the classification window based on the stored results of classification (S112).

If the user wants to continue the extraction and classification procedure (YES in S113), the sequential steps S103 to S113 are repeated while the classification window is opened.

The idea-drawing support procedure ends when the user checks the displayed results and stops the extraction and classification procedure (NO in step S113).

[2. Basic Function of idea-Drawing Support Procedure]

Under the idea-drawing support procedure disclosed above, the user is allowed to efficiently classify VOCs into groups over the several item windows in the classification window and selects VOCs in each group displayed on the item windows one by one, thus efficiently extracting required items while checking the VOC contents and their attribute information on the next-level-item windows.

The user is further allowed to efficiently classify the extracted required items into groups over the several item windows in the classification window and selects required items in each group displayed on the item windows one by one, thus efficiently extracting required qualities while checking the contents of the required items and their base VOCs and their attribute information on the next-level-item windows. Therefore, the user is allowed to efficiently classify the extracted required qualities into groups over the several item windows in the classification window.

Accordingly, according to the idea-drawing support procedure in this embodiment, the user is allowed efficient item extraction and classification with two steps procedure to check each item at a certain level on the next-level-item extraction window for extracting the next-level item, and to check several extracted next-level items on the classification window for item classification.

Moreover, the user is allowed to classify VOCs themselves into groups, thus eliminating extraction of identical required items for efficient extraction procedure.

In addition, the user is allowed on-screen operations using item character strings, etc., while checking the contents of several groups displayed on the several item windows in the classification window, thus user-initiative efficient item classification being achieved.

[3. Outline of Grouping Procedure]

According to the idea-drawing support procedure in this embodiment, the user is allowed user-friendly KJ- or Affinity-Diagram-method-like grouping with mouse clicking operations, as described below.

Firstly, the user appoints a data file on a start-up window, etc. The data file is a collection of VOCs having attribute information, such as, scene information shown in FIG. 2. The VOCs and attribute information are loaded to display a classification window, such as shown in FIG. 3. All of the loaded VOCs belong to a group in UNCLASSIFIED ITEM in FIG. 3. These VOCs are also displayed on a first item window IW1 among four (2×2)-item windows IW1 to IW4.

The user can group the total number “n” of the VOCs belonging to the group in UNCLASSIFIED ITEM according to their meanings or definitions, as described below.

The first operation for the user is to select an item I1 from VOCs belonging to a group G0 in UNCLASSIFIED ITEM displayed on the first item window IW1. He or she then drags the item I1 and drops it into the closed second item window IW2.

These operations create a new group G1 in the second item window IW2, so that the item I1 is shifted to the group G1. Displayed on the second item window IW2 is the entire character string of the VOC that is the item I1 as a temporal group name of the group G1. The temporal group name is also displayed on the group window GW.

Therefore, the user can creates the new group G1 just on the second item window IW2 and the group window GW and check that the item I1 has belonged to the group G1 under the grouping procedure. The displayed temporal group name can be changed according to needs.

Next, the user selects another item I2 from the VOC belonging to the group GO in UNCLASSIFIED ITEM and compares the item I2 with items already grouped, to perform a shift operation based on the comparison (comparison and shifting operation) for the grouping procedure to the item I2.

In detail, the user compares the item I2 with the item I1 already shifted to the group G1 to determine whether the former is close to the latter in definition or meaning.

On determination that the former is close to the latter, the user drags the item I2 and drops it into the group G1 to which the item I1 belongs, to shift it to the group G1.

In contrast, on determination that the former is not close to the latter, the user drags the item I2 and drops it into the closed third item window IW3, so that a new group G2 is created in the window IW3 and hence the item I1 is sifted to the group G2. Also displayed on the third item window IW3 and the group window GW is a temporal group name given to the group G2.

The user selects new items one by one from the VOCs belonging to the group GO in UNCLASSIFIED ITEM and repeats the comparison and shifting operation disclosed above.

If all item windows are opened at the time of creation of new groups, the user double-clicks groups of low importance at present to “close” them, to keep the item windows IW for creation of new groups.

Illustrated in FIG. 4 are items of three groups OPERATION, MACHINE and OTHERS among six groups OPERATION, MACHINE, BANK, TIME, BANKNOTE and OTHERS created on the classification window shown in FIG. 3.

On completion of grouping to all of the “n” number of VOCs in the group GO in UNCLASSIFIED ITEM, a group tree is constructed in the group window GW.

When the user has determined that an upper-level group can be created from combination of groups, he or she performs the drag-and-drop operation to the groups in the group tree in the group window GW for grouping.

The grouping can be repeated if the user determines that a further upper-level group can be created on completion of grouping to the same-level groups.

The sequential procedures disclosed above offers user-friendly KJ-method-like grouping for VoCs, required items and required qualities.

This grouping technique under the idea-drawing support procedure in this embodiment achieves far effective classification to a large number of items compared to a known KJ-method-like grouping with on-desk manual and two-dimensional item arrangements.

[4. Supplemental Explanation of Classification-Window Format]

The following is a supplemental explanation of the classification window with respect to FIG. 4, which has been briefly explained in the disclosure of the idea-drawing support procedure.

Shown in FIG. 4 above the classification window are a menu bar 410 with EDIT, VIEW, etc., and a tool bar 420 for several operations such as “new group creation”, “display properties”, etc.

Displayed in the tool bar 420 are a group-creation icon 421 for creation of new groups, a group-property 422 for displaying group properties, a classification-window icon 423 for displaying the classification window, a result-view window icon 424 for showing the results of operations, level-appointing icons 425a to 425c for displaying all groups in each level among three levels of VOC, REQUIRED ITEM and REQUIRED QUALITY, a level-switching icon 426 for displaying all groups at a level prior or next to the present level, a tree-diagram-screen icon 427 for displaying a tree-diagram screen, a contents-view-window-number change icon 428 for changing the number of contents-view windows, a contents-view-window rearrangements icon 429 for rearranging groups displayed on contents-view windows, etc.

A group tree 430 displayed on the group window GW consists of icons 431 and group names 432.

Provided above each of the item windows IW1 to IW4 is a group-name view zone 440 for displaying the name of the “opened” group. Attached to each group-name view zone 440 is a window-number zone 441 such as “1” to “4” for the item windows IW1 to IW4, respectively. When a group is “open”, the window number “1”, “2”, “3” or “4” of the item window in which the group is “open” is displayed on an icon 431 corresponding to the group.

Displayed on each group-name view zone 440 of the item windows IW1 to IW4 are the name at the present level among VOC, REQUIRED ITEM and REQUIRED QUALITY, in addition to a group name. A name at the next-level can also be displayed on each group-name view window. An item at the present level is displayed under the name at the present level. In addition, displayed under the name at the next level is the item at this level in relation to the item at the present level, the source of extraction of the next-level item.

[5. Details of On-Screen Extraction Procedure]

As disclosed, the next-level-item extraction window, such as shown in FIG. 5 or 6 is displayed for next-level-item extraction when the user selects an item displayed on an item window IW in the classification window to make a request for displaying a next-level-item extraction window, under the idea-drawing support procedure in this embodiment.

Disclosed below are the two types of next-level-item extraction window.

[5-1. Extraction Window]

Illustrated in FIG. 5 is a VOC-based next-level-item extraction window 500 displayed on the classification window.

Displayed on the VOC-based next-level-item extraction window 500 are VOC 501, SCENE INFORMATION 502, REQUIRED ITEM 503, INPUT ITEM 504, SELECT MODE 505 and ENTRY CANDIDATE 506.

Displayed under the REQUIRED ITEM 503 are ADD button 511, DELETE button 512 and PROPERTY button 513 for addition, deletion and property displaying, respectively, in the REQUIRED ITEM 503.

Displayed under the VOC 501 is a PROPERTY button 514 for displaying property of VOC 501.

Scene information displayed in SCENE 502 are attribute information, such as, gender, age, occupation and hobby of each person giving an opinion (customer); date and place of giving an opinion (making complaints); activity, the background of giving an opinion (complaints); action or environment, situations connected to the opinion (complaints); circumstances connected to opinion (complaints), etc.

The user is allowed to edit the contents of VOC 501 and SCENE 502.

The user is allowed to add the contents filled in the INPUT ITEM 504 to REQUIRED ITEM 503 by depressing the ADD button 511. This addition may be done for each of the contents in the INPUT ITEM 504. In addition, the contents to be added can be selected among candidates (of next level item) displayed in CANDIDATE 506 according to SELECT MODE 505. The user is allowed to select either NEXT-LEVEL ITEM CANDIDATE created by dividing each VOC (the base or source of extraction) with punctuation or INPUT HISTORY for retrieving already-created required items.

Next, illustrated in FIG. 6 is a required-item (RI)-based next-level-item extraction window 600 displayed on the classification window.

Displayed on the RI-based next-level-item extraction window 600 are VOC 601 (the base or source of extraction), SCENE 602, REQUIRED ITEM 603, REQUIRED QUALITY 604, INPUT ITEM 605, SELECT MODE 606 and ENTRY CANDIDATE 607.

Displayed under the REQUIRED QUALITY 604 are ADD button 611, DELETE button 612 and PROPERTY button 613 for addition, deletion and property displaying, respectively, in the REQUIRED QUALITY 604.

Displayed under the REQUIRED ITEM 603 and VOC 601 are PROPERTY buttons 614 and 615 for displaying property windows for REQUIRED ITEM 603 and VOC 601, respectively.

Like on the VOC-based next-level-item extraction window 500, the user is allowed to add the contents filled in the INPUT ITEM 605 to REQUIRED QUALITY 604 by depressing the ADD button 611. This addition may be done for each of the contents in the INPUT ITEM 607. The user is further allowed to select either NEXT-LEVEL ITEM CANDIDATE or INPUT HISTORY under SELECT MODE 66, like on the VOC-based next-level-item extraction window 500.

[5. 2 Extraction Procedure]

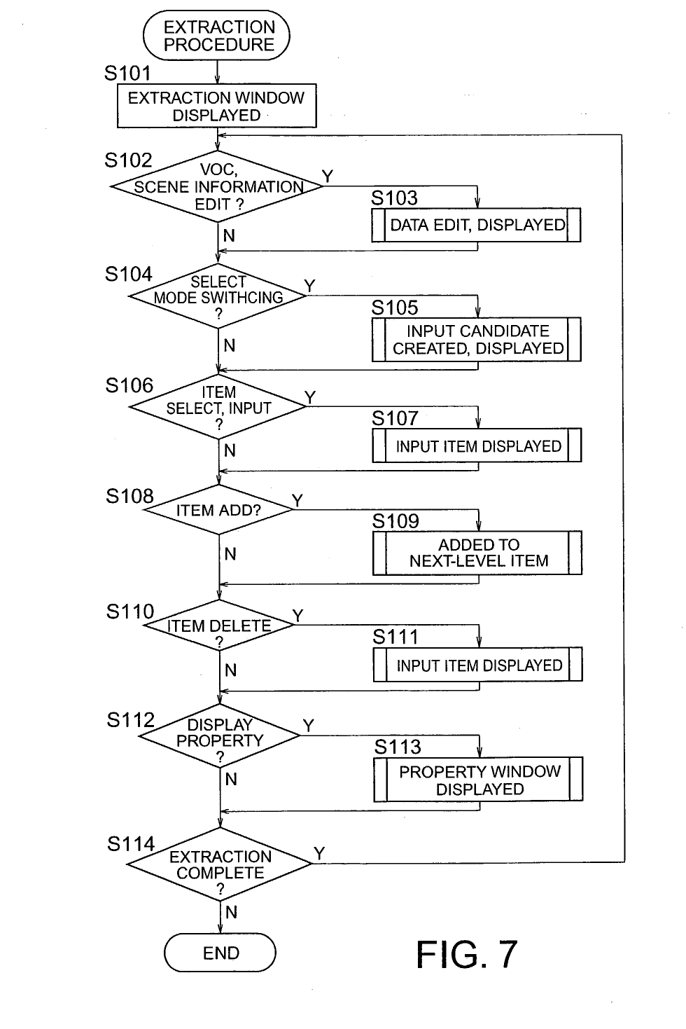

FIG. 7 is a flowchart indicating an on-screen user-operation-based extraction procedure on the next-level-item extraction window that can be used as a subroutine for the extraction procedure (S104) in the idea-drawing support procedure shown in FIG. 1.

Disclosed below in detail with reference to FIGS. 5 to 7 are user operations on the next-level-item extraction window (FIG. 5 or 6) and the corresponding extraction procedure.

The VOC-based next-level-item extraction window 500 (FIG. 5) is opened in the classification window (S701) when the user selects one item on an item window IW in the classification window and makes a request for opening this next-level-item extraction window, for example, by double-clicking, while a VOC is displayed on the item window IW and the VOC-level-appointing icon 425a is active.

Preset in SELECT MODE 505 in configuration settings (described later) is initial reference information in creation of a next item. Several candidates are automatically created according to the mode set in SELECT MODE 505 and displayed in CANDIDATE 506 with other information when the VOC-based next-level-item extraction window 500 is opened. FIG. 5 shows NEXT-LEVEL ITEM CANDIDATE in SELECT MODE 505 and several candidates in CANDIDATE 506, created by dividing the VOC now displayed (the source or base of extraction) with punctuation.

The user compares the contents of VOC 501, SCENE 502 and CANDIDATE 506 with each other for extraction of required items.

When the user performs an edit operation to VOC and scene information (YES in S702), these data are edited and displayed on VOC 501 and SCENE 502, respectively (S703).

In contrast, when the user performs a switching operation to the contents in SELECT MODE 505 (YES in S704), a new candidate is created according to the switched select mode and displayed on CANDIDATE 506. A certain number of required items are retrieved from the list of already created required items when the SELECT MODE 505 is switched from NEXT-LEVEL ITEM CANDIDATE to INPUT HISTORY.

When the user selects one candidate in CANDIDATE 506 or enters items one by one in INPUT ITEM 504, with no candidate selection (YES in S706), the selected or entered item is displayed on INPUT ITEM 504 (S707).

The user is allowed to edit the item displayed on INPUT ITEM 504. For example, when he or she depresses the ADD button 511 while the item is displayed on INPUT ITEM 504 (YES in S708), this item is added to required items (the next-level items) in REQUIRED ITEM 503 (S709). When the user selects one of the required items (the next-level items) in REQUIRED ITEM 503 and depresses the DELETE button 512 (YES in S710), the selected required item is deleted from REQUIRED ITEM 503 (S711). Two or more of the required items (the next-level items) can be selected and deleted from REQUIRED ITEM 503.

When the user selects one of the required items (the next-level items) in REQUIRED ITEM 503 and depresses the PROPERTY button 513 or the other PROPERTY button 514 for VOC 501 (YES in S712), a property window for REQUIRED ITEM 503 or VOC 501 is opened (S713). Displayed on the property window for VOC 501 are VOC as property information and attribute information other than scene information. In contrast, displayed on the property window for REQUIRED ITEM 503 are VOC (the source or base of extraction) and its attribute information other than scene information. A user-comment fill-in blank may be provided.

The VOC-based next-level-item extraction window 500 is closed and the screen returns to the classification window when the user completes the extraction procedure (YES in S714).

The RI (Required Item)-based next-level-item extraction window 600 (FIG. 6) is opened in the classification window (S701) instead of the VOC-based next-level-item extraction window 500 (FIG. 5) when the user selects one item in an item window IW in the classification window and makes a request for opening this next-level-item extraction window, for example, by double-clicking, while required items are displayed on the item window IW and the RI-level-appointing icon 425b is active (S701).

The procedure of extracting required qualities from required items on the RI-based next-level-item extraction window 600 is substantially the same as the procedure of extracting required items from VOCs on the VOC-based next-level-item extraction window 500 and hence not disclosed for brevity.

[5. 3 Automatic Candidate Creation Procedure]

In the extraction procedure disclosed above, the task for the user in candidates entry is selection of automatically created candidates of next-level item, without entering next-level items one by one. The user is allowed to correct a sentence expressing each selected candidate. Thus, the present invention offers a user-friendly extraction procedure.

Disclosed below in detail is an automatic candidate creation procedure.

Disclosed so far for the automatic VOC-divided candidate creation procedure starts with division of VOC, the source of extraction, by punctuation.

Nevertheless, the automatic VOC-divided candidate creation procedure offers several options for VOC division. In detail, VOC is divided by punctuation, parentheses, quotation marks or character strings, in accordance with how VOC, the source of extraction, is expressed, how work data are used, etc.

The automatic VOC-divided candidate creation procedure is feasible when a part of a VOC expressing a demand.

In contrast, the automatic input-history-based candidate creation procedure retrieves the latest defined certain number (for example, five) of required items from the input history and display them from the latest one.

The automatic input-history-based candidate creation is feasible in the extraction procedure with VOCs divided into groups in this embodiment that often requires sequential extraction of similar required items from similar VOCs.

In addition to these automatic candidate creation procedures, candidates of next-level item can be automatically created through searching for the character strings of already entered items in a list of items containing user-selected character strings. Such item list may be created from a VOC list or a list of already created required items.

The extraction procedure disclosed above gives the user the task of selecting candidates of next-level item. Next-level items may, however, be automatically created by using automatically created candidates as the next-level items with no modifications to the candidates. This automatic item creation may be initiated by the user to select one of several candidate creation procedures or to decide the maximum number of candidates to be created for each VOC.

[5.4 Supplemental Explanation for Use of Scene Information]

The scene information used in the extraction procedure in this embodiment are attribute information, such as, gender, age, occupation and hobby of each person giving an opinion (customer); date and place of giving an opinion (making complaints); activity, the background of giving an opinion (making complaints); action or environment, situations connected to the opinion (complaints); circumstances connected to opinion (complaints),etc. The scene information is a useful information for understanding person's opinion (customer's voice).

The extraction procedure in this embodiment allows the user to display these useful information only as the scene information for grasping what complaints really means, thus efficiently extracting accurate information from VOCs.

Disclosed below in detail is use of the scene information.

The scene information may be added to each VOC beforehand. Or, attribute information added to each VOC that meet certain requirements may be loaded as the scene information. For example, each VOC-added attribute information may be automatically determined whether it is information on 5W1H (Who, What, When, Where, Why and How) by syntactic parsing, etc., while each VOC is loaded.

Displaying 5W1H-related attribute information as the scene information on the extraction window is very feasible in VOC-based demand extraction. This is because information on 5W1H in customers' voices among VOC-added attribute information helps the user grasp customers' real meaning. The 5W1H-related attribute information is such as “a voice of a high-school girl” and “a voice of a salaried worker in his thirties”.

Not only the customers, but also information on an interviewer and a user performing the idea-drawing support procedure can be treated as 5W1H-related attribute information. Moreover, the time at which a VOC is loaded, information on the user who loaded the VOC, information on a data creator who draws a next-level idea or a person who modified data and information on data-created time, data-modified time, etc., can be treated as 5W1H-related attribute information.

Furthermore, not only 5W1H-related information, but also other attribute information can be selected and displayed as scene information according to needs.

The extraction procedure on the extraction window such as shown in FIG. 5 allows the user to edit the scene information during the extraction procedure for writing or adding information among several types of VOC-attached attribute information required at present as the scene information.

Nevertheless, the extraction procedure in this embodiment allows the user to open a property window to list up several types of VOC-attached attribute information other than the scene information without such edition of scene information.

The extraction procedure in this embodiment further gives the user a chance to draw potential demands or new needs by demand extraction with scene information replacements irrespective of who are customers. For example, when an elderly person complained that the screen is complicated. This VOC can be speculated as a demand on the size of characters. The replacement of the elderly person with a young person offers speculation of another demand.

In relation to this, an attribute value or level of scene information can be automatically replaced with another value or level, such as, an attribute level of “60's” to “20's” for an attribute “age group”, an attribute value of “male” to “female” for an attribute “gender” and an attribute value of “foreign nationality” to “Japanese nationality” for an attribute “nationality”.

The on-screen automatic attribute value/level replacements feasible than user-manual scene-information replacements offer extraction of unexpected new demands or needs.

[6. Details of On-Screen Classification Procedure]

The idea-drawing support procedure in this embodiment offers several item windows for displaying items in on-screen item and/or group handling for efficient classification procedure, thus taking peculiar steps.

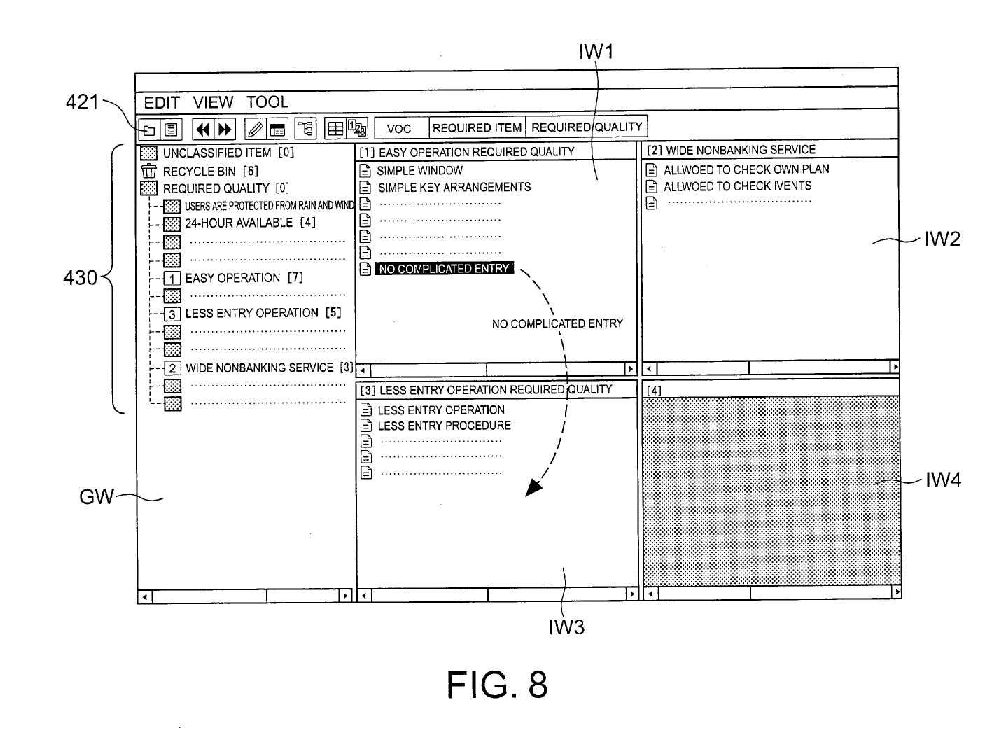

FIG. 8 shows a classification window similar to that in FIG. 4, illustrating item handling on item windows. Illustrated in FIG. 8 is on-screen required-quality (RQ) handlings while required qualities are displayed on item windows in the classification window and a RQ-level-appointing icon 425c is active.

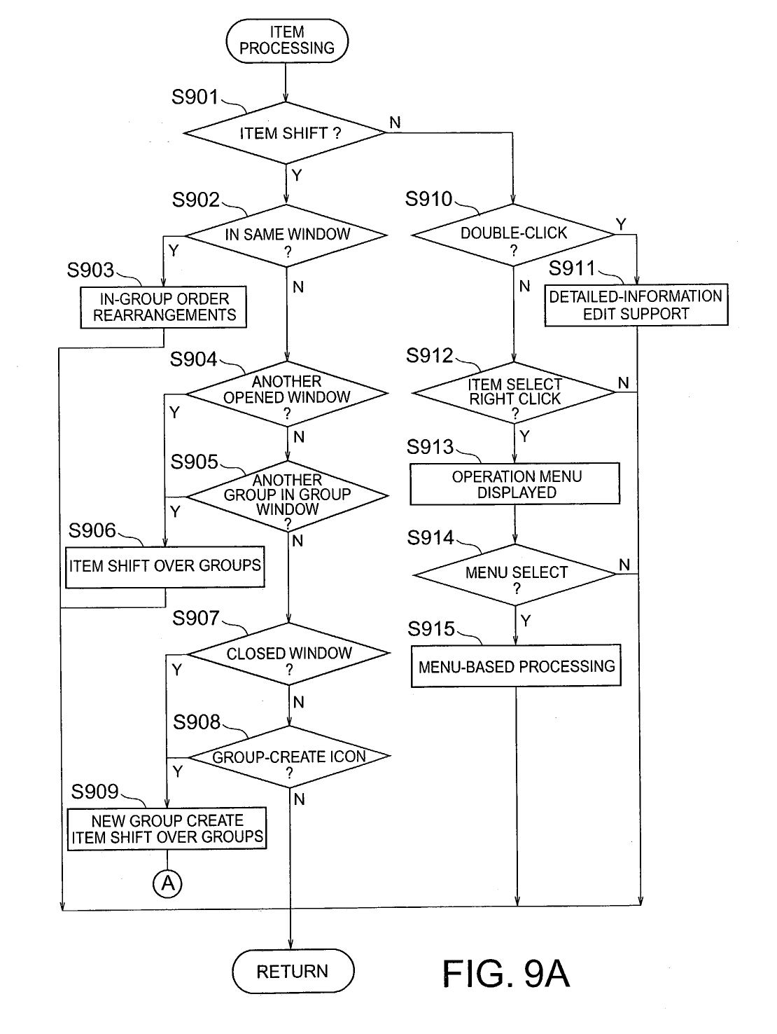

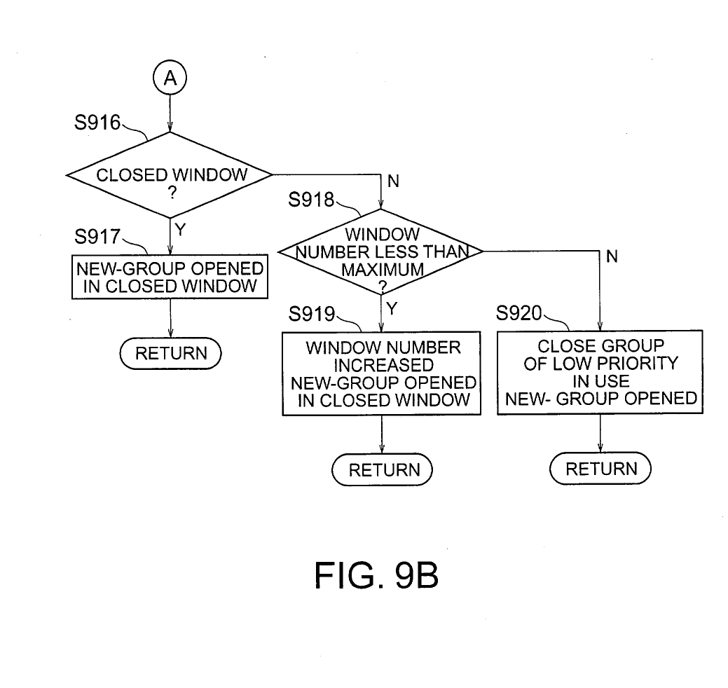

FIGS. 9A and 9B are flowcharts indicating an on-screen item processing sequence that can be used as a subroutine for the item processing (S106) in the idea-drawing support procedure shown in FIG. 1.

Disclosed below in detail with reference to FIGS. 8, 9A and 9B are item handling on item windows and its item processing sequence.

Suppose that the user performs a drag-and-drop operation to one item NO COMPLEX ENTRY in a group EASY OPERATION displayed in the first item window IW1, for item shifting (YES in S901).

The subsequent procedure depends on into which window the item has been dropped.

In-group item-order change is performed (S903) in accordance with the location of the item in the first item window IW1 if it has been shifted in this same window IW1 in which it has existed from the beginning (YES in S902).

In contrast, suppose that the item NO COMPLEX ENTRY in the first item window IW1 has been shifted to the opened second item window IW2 or third item window IW3 (YES in S904) or any group other than the group EASY OPERATION displayed in the group window GW (YES in S905).

Either case requires that the group to which the item NO COMPLEX ENTRY belongs be changed to another, in accordance with the location of the shifted item (S906).

For example, if the item NO COMPLEX ENTRY has been shifted to the second item window IW2, it belongs to a group WIDE NONBANKING SERVICE . . . “opened” in the window IW2.

Moreover, if the item NO COMPLEX ENTRY has been shifted to a group 24-HOUR AVAILABLE in the group window GW, it belongs to this group.

On the contrary, suppose that the item NO COMPLEX ENTRY in the first item window IWI has been shifted to the closed fourth item window IW4 (YES in S907) or the group-creation icon 421 in the tool bar 420 (YES in S908).

Either case requires that the closed fourth item window IW4 be opened to create a new group to which the item NO COMPLEX ENTRY belongs (S909). The new group is given a temporal group name NO COMPLEX ENTRY the same as the entire character string of the shifted item. The temporal group name is displayed on the group-name displaying zone 440 and also the group tree 430 in the group window GW.

FIG. 8 illustrates the classification window on which the item window IW4 is closed (YES in step S916 in FIG. 9B). Thus, a new group is “opened” in this closed window IW4 (S917 in FIG. 9B).

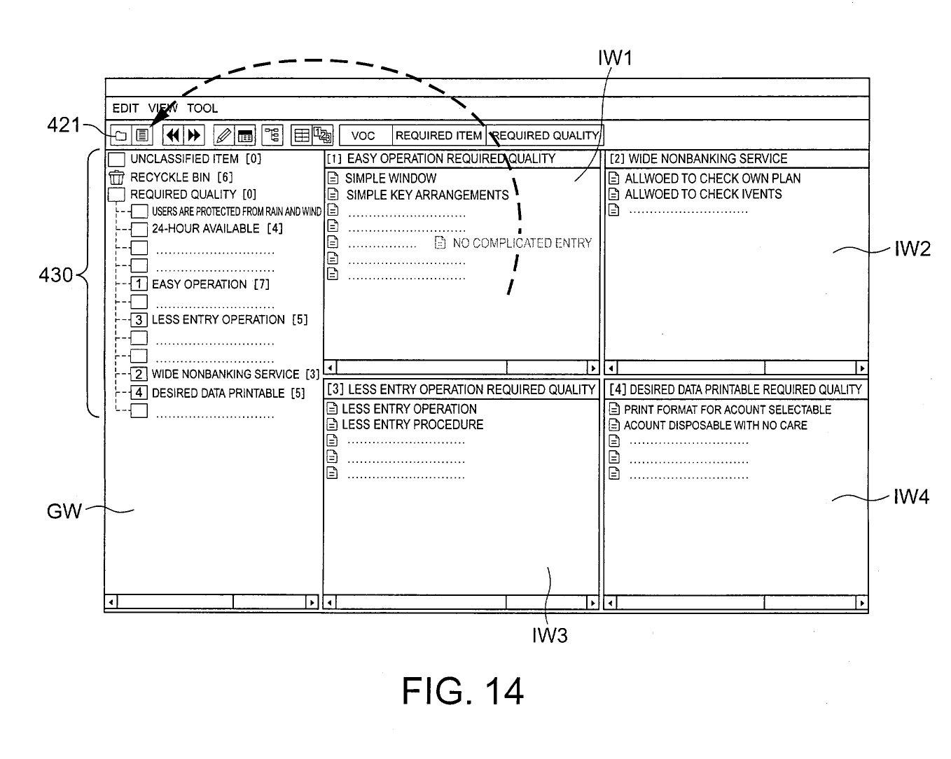

In contrast, FIG. 14 illustrates the classification window on which the item window IW4 is opened and a group has been “opened” therein, hence no item windows IW being closed (NO in step S916 in FIG. 9B).

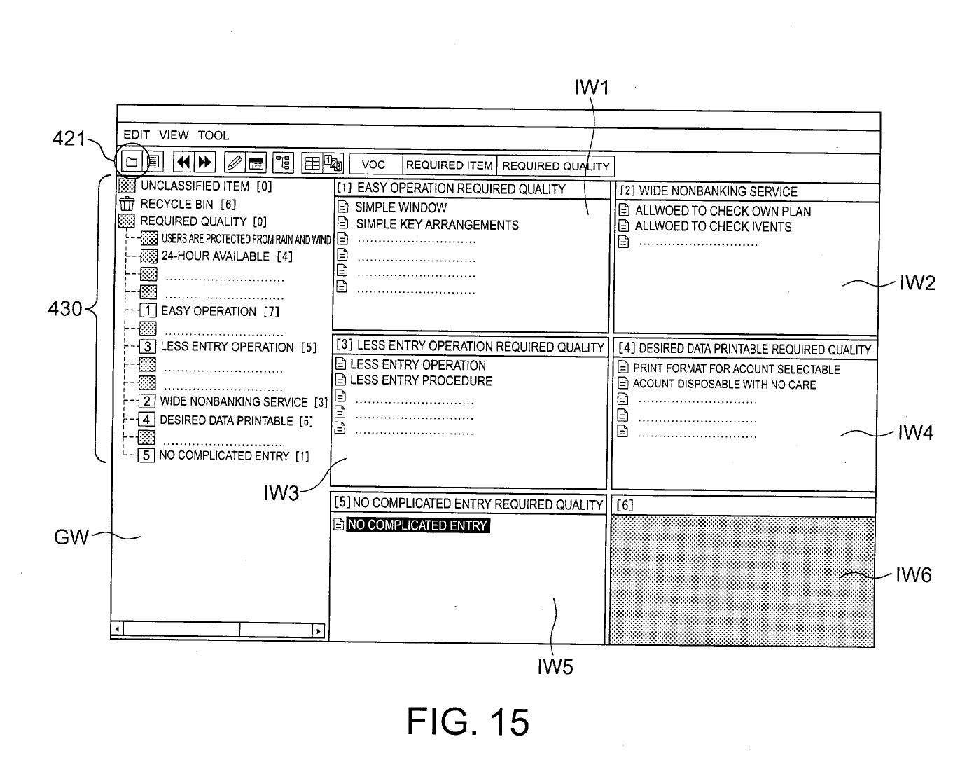

In case of FIG. 14, if the number of item windows IW can be increased (YES in step S918 in FIG. 9B), the rows or columns of item windows IW are increased to provide new item windows, such as, item windows IW5 and IW6 shown in FIG. 15, and a new group is “opened” in the closed item window IW5 (S919 in FIG. 9B).

On the contrary, if the number of item windows IW cannot be increased any more (NO in step S918 in FIG. 9B), an item window IW in which a group of low priority in use is “open” is closed to “close” this group and a new group is “opened” in this closed item window IW (S920 in FIG. 9B).

Different from the above procedure, if the user double-clicks an item in the item window IW1 (NO in S901, YES in S910 in FIG. 9A), a detailed-information window is opened to support the user detailed-information edition (S911).

The next-level-item extraction window, such as, shown in FIG. 5 or 6 is displayed as the detailed-information window at VOC- or RI-level extraction. Displayed on the detailed-information window at the RQ-level extraction are required qualities, required items, the source of extraction of the required qualities, VOCs, VOC-added scene information, etc.

Like the next-level-item extraction window, such as, shown in FIG. 5 or 6, the user is allowed to open a property window for required qualities, required items and VOCs on the detailed-information window.

In contrast, if the user selects an item and presses the right button of a mouse (YES in S912), an operation menu is opened (S913), which includes several commands such as “detailed information”, “item delete”, “item search” and “property”, for processing according to user menu selection (YES in S914, S915).

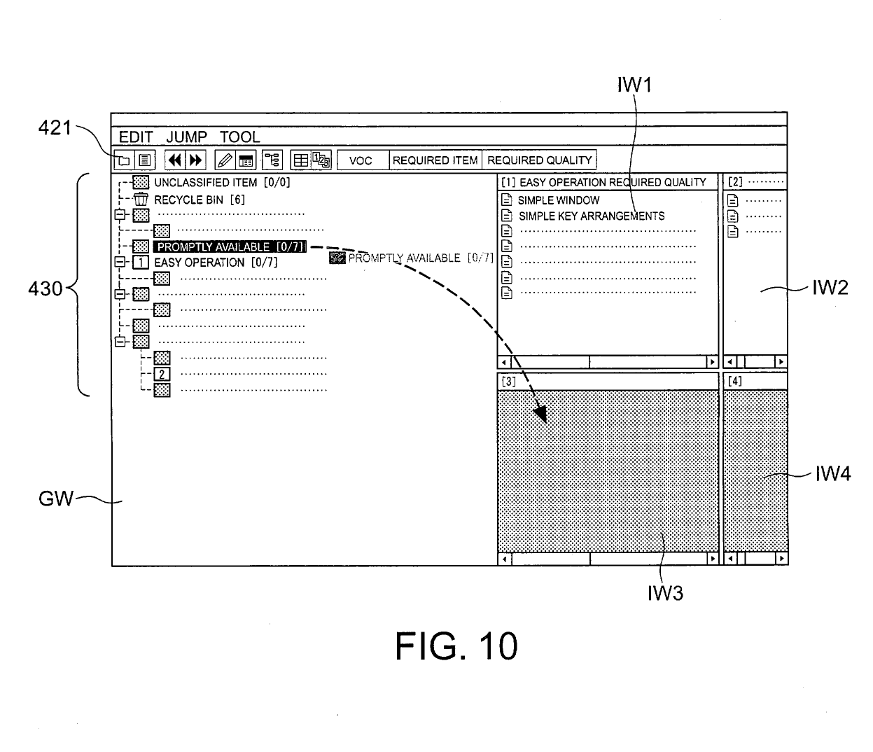

FIG. 10 shows a classification window similar to that in FIGS. 4 and 8, illustrating group handling on a group window. Illustrated in FIG. 10 are on-screen group handlings of required-quality (RQ) while required qualities are displayed on item windows in the classification window and a RQ-level-appointing icon 425c is active.

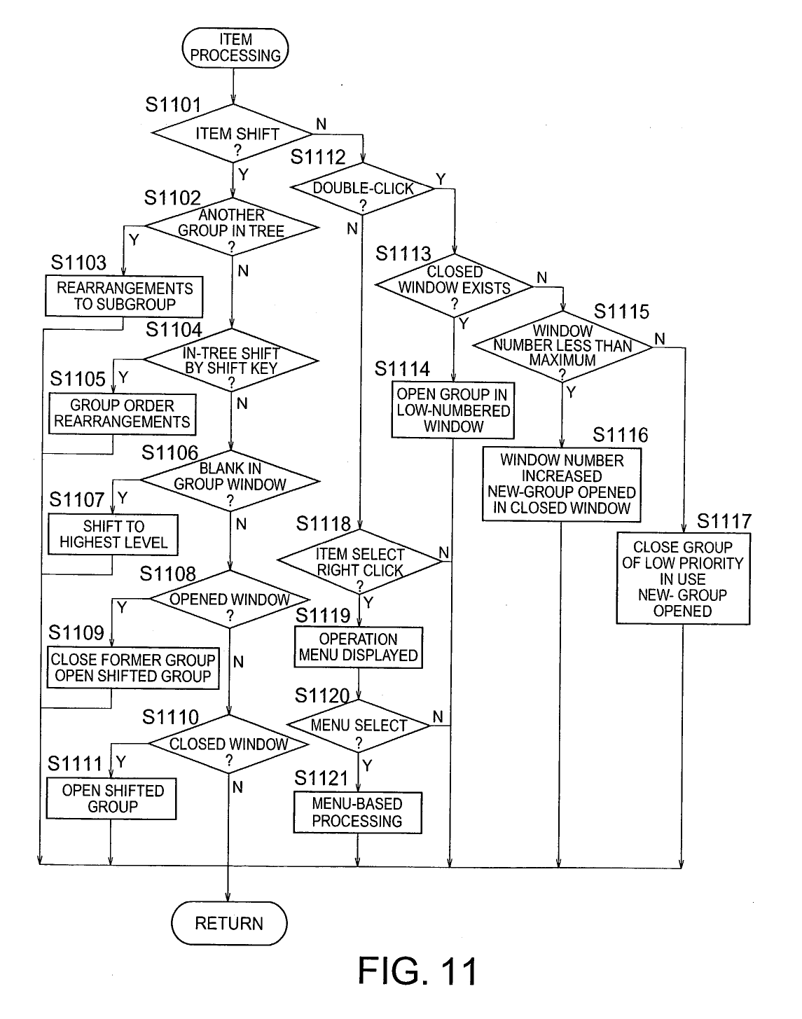

FIG. 11 is a flowchart indicating the on-screen group processing sequence that can be used as a subroutine for the group processing (S108) in the idea-drawing support procedure shown in FIG. 1.

Disclosed below in detail with reference to FIGS. 10 and 11 are group handling on a group window and its group processing sequence.

Suppose that the user performs a drag-and-drop operation to one “closed” group PROMPTLY AVAILABLE in a group window GW for group shifting (YES in S1101).

The subsequent procedure depends on into which the group has been dropped.

If the group PROMPTLY AVAILABLE has been shifted to another group in the group window GW (YES in S1102), the former shifted group is modified as a subgroup of the latter group (S1103).

In contrast, if the user drops the group PROMPTLY AVAILABLE into a group tree 430 in the group window GW while pressing a shift key (YES in S1104), the order of groups is changed in accordance with the location of the dropped item (S1105).

If the destination of the group PROMPTLY AVAILABLE is a blank column outside the group tree 430 in the group window GW (YES in S1106), this group is moved to the highest level in the tree 430 but in the lowest rank in the highest level (S1107).

If the group PROMPTLY AVAILABLE in the group window GW has been shifted to a first item window IW1 in which a group EASY OPERATION is “open” (YES in S1108), the group EASY OPERATION is “closed” while the group PROMPTLY AVAILABLE is “opened” (S1109)

If the group PROMPTLY AVAILABLE in the group window GW has been shift to a closed item window IW3 (YES in S1110), this group is “opened” in the window IW3 (S111).

Different from the above procedure, suppose that the user double-clicks a group in the group window GW (NO in S1101, YES in S1112).

If both item windows IW3 and IW4 are “closed” (YES in S1113), the double-clicked group is “opened” in the window IW3 given the smaller window number “3” (S1114).

In contrast, if no item windows are “closed” (NO in S1113), and if the number of item windows IW can be increased (YES in step S1115), the rows or columns of item windows IW are increased to provide new item windows, such as, item windows IW5 and IW6 shown in FIG. 15, and a new group is “opened” in the closed item window IW5 (S1116).

On the contrary, if the number of item windows IW cannot be increased any more (NO in step S1115), an item window IW in which a group of low priority in use is “open” is closed to “close” this group and a new group is “opened” in this closed item window IW (S1117).

Contrary to this, if the user selects a group and presses the right button of a mouse (YES in S1118), an operation menu is opened (S1119), which includes several commands such as “create new subgroup”, “group delete”, “property”, “classify by attribute” and “prior group succeed” for processing according to user menu selection (YES in S1120, S1121).

A property window containing group names is opened if the command “property” is selected. The user is allowed to change any group name on the property window.

The on-screen group processing for a group displayed as a subgroup in an item window is basically similar to the item processing shown in FIGS. 9A and 9B, except some steps.

In detail, a group is displayed on an item window which has been closed if shifted from another item window in which it has been displayed as a subgroup. Moreover, if a subgroup in an item window is doubled-clicked, a group already “opened” in this item window is “closed” and the doubled-clicked lower group is newly “opened” instead.

[7. Outline of Operation Menu]

Not only the on-screen item/group shifting disclosed above, the idea-drawing support procedure in this embodiment offers several on-screen operations, as disclosed below, with the operation menu displayed as icons on the menu bar 410 in the classification window shown in FIG. 4.

An edit icon 411 on the menu bar 410 displays several commands such as “operate item window” and “operate group window”. A further detailed operation menu is displayed when the corresponding command is selected. Further selection of commands on the displayed operation menu initiates processing similar to the item/group shifting disclosed above and other processing.

Commands listed in the operation menu on the group window are such as “classify by attribute” and “prior group succeed”, like the operation menu for the group processing disclosed above.

A display icon 412 on the menu bar 410 displays several commands such as “display upper level”, “display lower level”, “display table screen” and “display tree diagram screen”.

A tool icon 413 on the menu bar 410 displays several tools such as “execute external application”, “configuration settings”, “delete duplicate data” and “file merge”. Selection of these tools initiates the corresponding processing.

The tool “execute external application” allows the user to select external commands such as “classify by key word” for classification according to user-specified key words and “produce questionnaire” for producing a certain format of questionnaires with questions made from work data.

The tool “configuration settings” allows executable-configuration setup to the user, including tools such as “the number of item windows” that allows the user to set the number of item windows and “initial reference information in creation of next item”.

The tool “delete duplicate data” allows the user to delete duplicates of item according to user-specified delete requirements.

The tool “file merge” is to load data in an opened file into another file for the user to determine whether to delete all duplicates of item at once.

[8. Several Types of Processing]

In addition to the on-screen item/group shifting disclosed above, the idea-drawing support procedure in this embodiment offers several types of processing according to user operations on the menu bar 410, the tool bar 420, etc.

[8-1. Change in the Number of Item Windows]

The number of item windows on the classification window shown in FIG. 4 can be changed within a predetermined range with row/column-number settings. For example, settings for the number of row in the range from 1 to 4 and column in the range from 1 to 6 allow changing the number of the item windows IW in the range from 1 to 24.

As shown in FIG. 4, the four item windows IW with two rows and two columns displayed at the initial settings could not display the contents of all groups if the number of groups is larger than four.

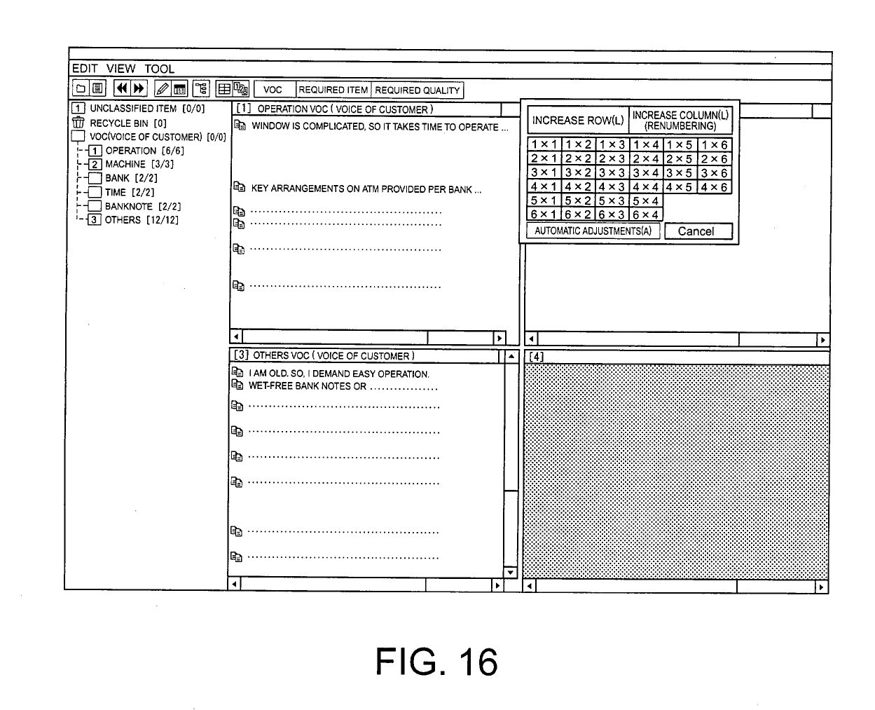

Under this situation, the user is allowed to press the contents-view-window-number changing icon 428 to display a classification window such as shown in FIG. 16.

Depressinga “3×3” button on this classification window changes the number of item windows IW on the classification window to nine (3 in row, 3 in column).

In contrast, depressing a “increase in row” button increases the number of row by one on this classification window, instead of specifying the number of row and column. Displayed in FIG. 15 are six (3 in row, 2 in column) item windows IW by depressing the “increase in row” button.

Accordingly, the user is allowed to increase the number of item windows IW without counting the number of row and column. In the same way, the user is allowed to increase the number of column by depressing a “increase in column” button.

As disclosed above, the user is allowed to change the number of the item windows any time during the classification procedure.

Moreover, when the user wants to scale up the size of each window while reducing the number of groups to be displayed, it is allowed to reduce the number of rows and columns, thus reducing the number of item windows.

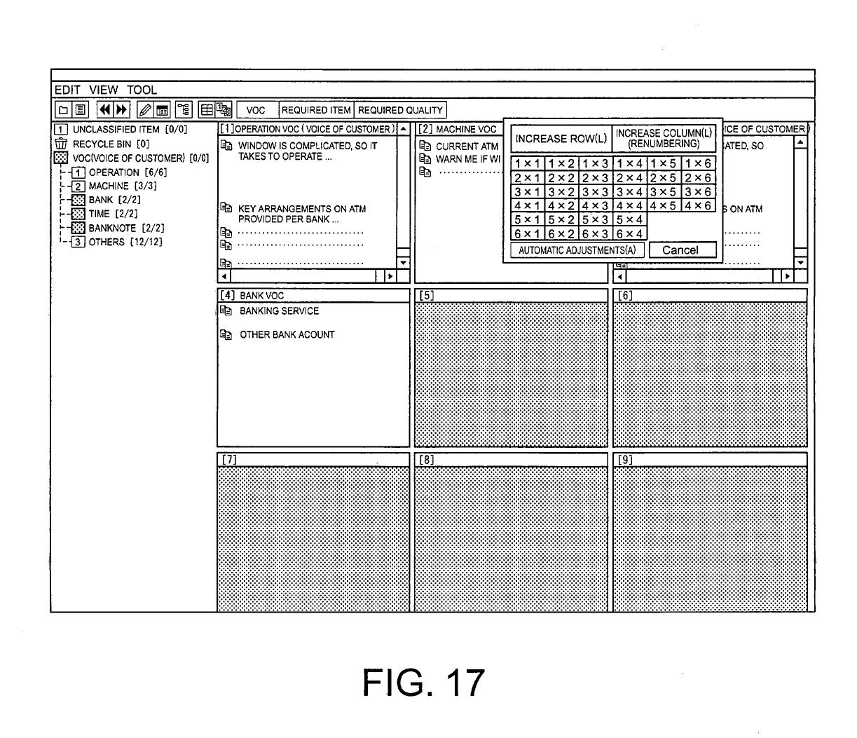

Illustrated in FIG. 17 is the classification window displayed when the contents-view-window-number changing icon 428 is depressed, like shown in FIG. 16. Four item windows IW are only opened although there are nine item windows IW in total.

The user is then allowed to depress a “automatic adjustments” button to decrease the total number of item windows IW to four that corresponds the number of item windows IW opened at present, to display the item windows IW again. The displayed item windows IW are scaled up to an easily-viewable size. The number of row and column for the item windows IW may be decreased to the same or similar number to achieve the easily-viewable size. For example, change in the number to two in row and two in column offers item windows IW of four in total.

Irrespective of the number of item windows, like usual windows, the size of each item window in the classification window and also the total size of all item windows can be scaled up or down. Thus, the user can change the window size with dragging on window frames according to user operation requirements, such as, to scale up the size of one or more of item windows or scale up the item windows larger than the group window or vice versa.

[8-2. Batch Processing Support Procedure]

The idea-drawing support procedure in this embodiment further supports batch item/group processing.

In detail, when the user appoints a certain level of hierarchy, with the hierarchy-appointment icon 425 or the hierarchy-level switching icon 426, all groups at the appointed level are displayed on the item windows IW at the same time.

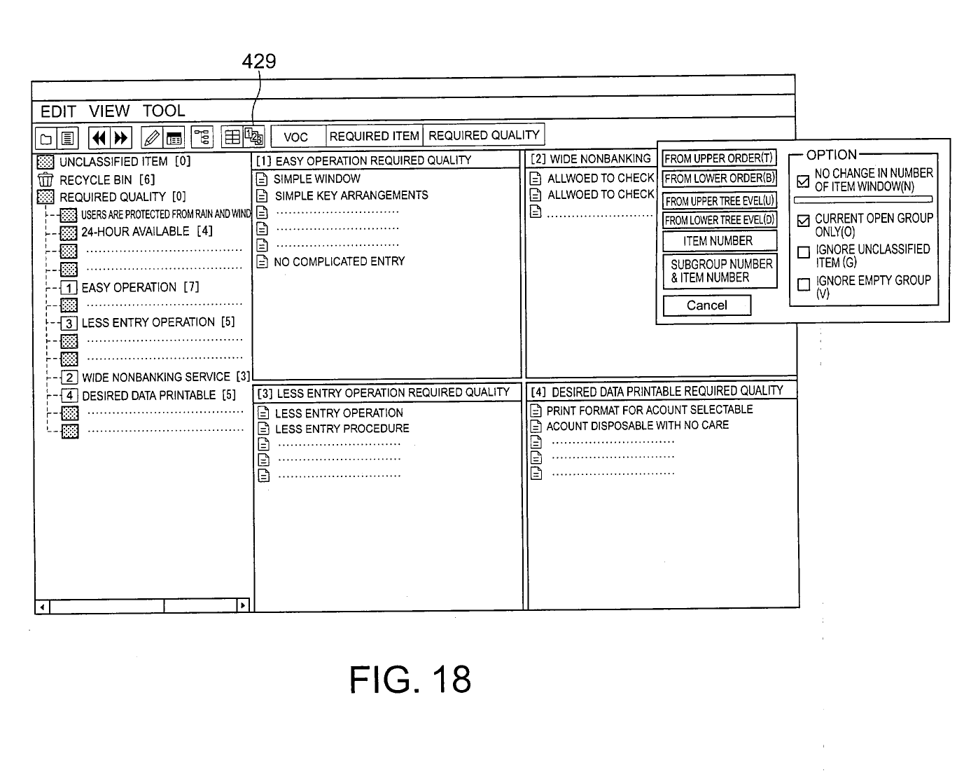

Moreover, the user is allowed to depress the contents-view-window rearrangements icon 429 shown in FIG. 16 to display windows such as shown in FIG. 18. These windows offer the user a widow-rearrangements function under several requirements, such as, rearranging item windows IW in order of the number of groups having larger number of items or in order of groups displayed on the group window GW.

Groups or items are subjected to the batch processing when selected in an item window with the shift key. This allows the user to shift or delete the selected groups or items at the same time with the drag-and-drop operation or using a delete key.

The user is further allowed batch processing to all items in a group through appointment of the group and execution of commands on the group operation menu.

An item-processing command is different from a group-processing command for quick batch item processing.

This embodiment offers automatic creation of groups from items. When the user wants to set a sub-item under an item in idea drawings, a group that used to have the sub-item may be converted into the item in idea drawings. The automatic item-to-group conversion or vise versa offers quick user operations. Groups may be automatically deleted when they have no elements such as items any longer.

Several duplicate items are deleted at the same time according to the range and requirements of deletion specified by the user with selection of the tool “delete duplicate data” on-the tool icon 413.

The user is allowed to delete groups or items. Prepared as the requirements of deletion are “all item character strings and all attributes are identical” and “item character strings are identical”. The user can select either of the requirements can be selected need to delete duplicate data.

[8-3. Automatic Classification]

Items can be automatically classified into groups in accordance with their attribute values and displayed on different item windows according to groups.

The user is allowed this automatic classification with specifying the attributes under selection of the command “classify by attribute” on the operation menu in on-screen group handling or on the operation menu in the group window displayed by clicking the edit icon 411. The attribute values are used as group names.

Therefore, the tasks for the user are just selection of the command “classify by attribute” and specifying the attributes. Hence, the user can quickly check the results of classification on several item windows.

In VOC classification, the user is allowed to select attribute information by which VOCs are to be classified, to create groups having names of the attribute information and then a VOC group per attribute value or level. Further allowed for the user in VOC classification are classification at two or more levels under several specified attributes and classification of VOCs in certain groups only. Classification by attribute can be applied to required items in addition to VOCs.

Another type of automatic classification offered in this embodiment is classification according to key words.

The user is allowed this automatic classification with selection of the tool “execute external application” and the command “classify by key word” on the tool icon 413. The list of all items is then displayed and the number of words often appearing in the items is counted. For example, top ten most appeared words are selected as keywords to initiate the automatic classification according to whether the items contain these key words. The items are divided into groups according to the key words and displayed on the item windows according to the groups. The keywords are used as group names.

Accordingly, the tasks for the user are just selection of the tool “execute external application” and the command “classify by key word”. Hence, the user can quickly check the results of classification on the several item windows.

In this keyword-based classification, the user may be allowed to set the number of words as requirements of classification or select keywords among automatically extracted keyword candidates. This offers user-initiative keyword-based classification.

The results of classification at the prior level are succeeded to the next classification when the user selects the command “prior group succeed” on the operation menu displayed during on-screen grouping at a certain level or on the group window via the edit icon 411.

For example, the command “prior group succeed” in on-screen group handlings at the required-item level succeeds the results of classification at the VOC level, the prior level, for classification of required items under the same group name and hierarchical structure.

This succession classification procedure offers automatic classification of items at the present level in accordance with the prior-level classification results, with the single user task, the selection of the command “prior group succeed”.

Another option is automatic hierarchical classification in accordance with abstractiveness of parts of speech under a command “classify by part of speech” on the operation menu.

In detail, automatic hierarchical classification in accordance with abstractiveness is achieved with syntactic parsing under the requirements such as “adjective only”, “adjective and verb” and “adjective, verb and noun”. The user task for automatic item classification is selection of the command “classify by part of speech” only.

[8-4. File Merge]

Data of a file are loaded and merged when the file is selected other than another data file now open, with the tool “file merge” on the tool icon 413. If the user selects the tool “delete duplicate data” in execution of “file merge”, data identical to items in the opened data file are automatically deleted, among the loaded data, thus items having not duplicates being only merged.

Moreover, identical data over hierarchies, groups, etc., are consolidated in the file merge procedure whereas unconsolidated but identical items are merged into a new group, thus work data created separately being merged into one group.

In addition, a loaded file may be modified in accordance with the results of classification on work data opened now, the results automatically coming first and reflected on the loaded file. Furthermore, work data may be modified in accordance with classification of other work data of a data file given high priority beforehand or at the time of file loading, thus work data created separately being modified and merged in accordance with classification of user-specified work data.

[8-5. Result-View Window]

The result-view window icon 424 allows the user to display a result-view window different from the classification window. The result-view window is usually the table screen for listing up items per level of hierarchy.

The table screen and the classification window can be switched to each other with a single action to the classification-window icon 423 or the result-window icon 424. In detail, a user single-click action to make active an item on the table screen switched from the classification window makes active the same item on the classification window switched from the table screen, for non-stop classification, with no further action to make active the item on the classification window.

The result-view window may be composed of one display format. Or, several different types of window format may be offered which allows the user to select any format for checking and evaluating the results of classification from several points of view.

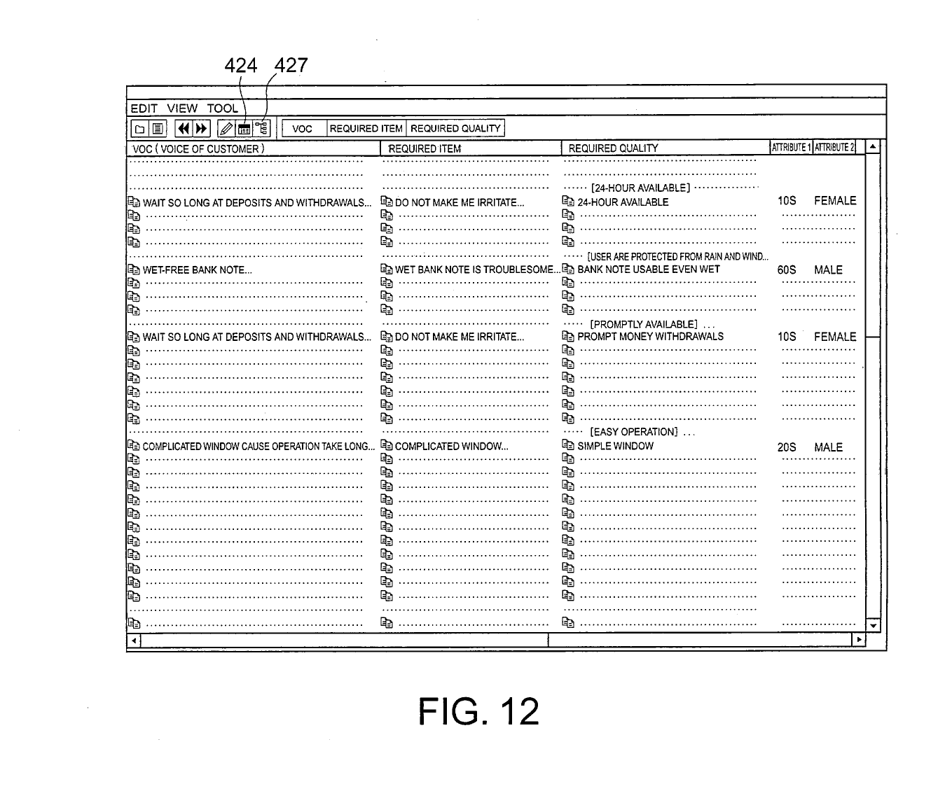

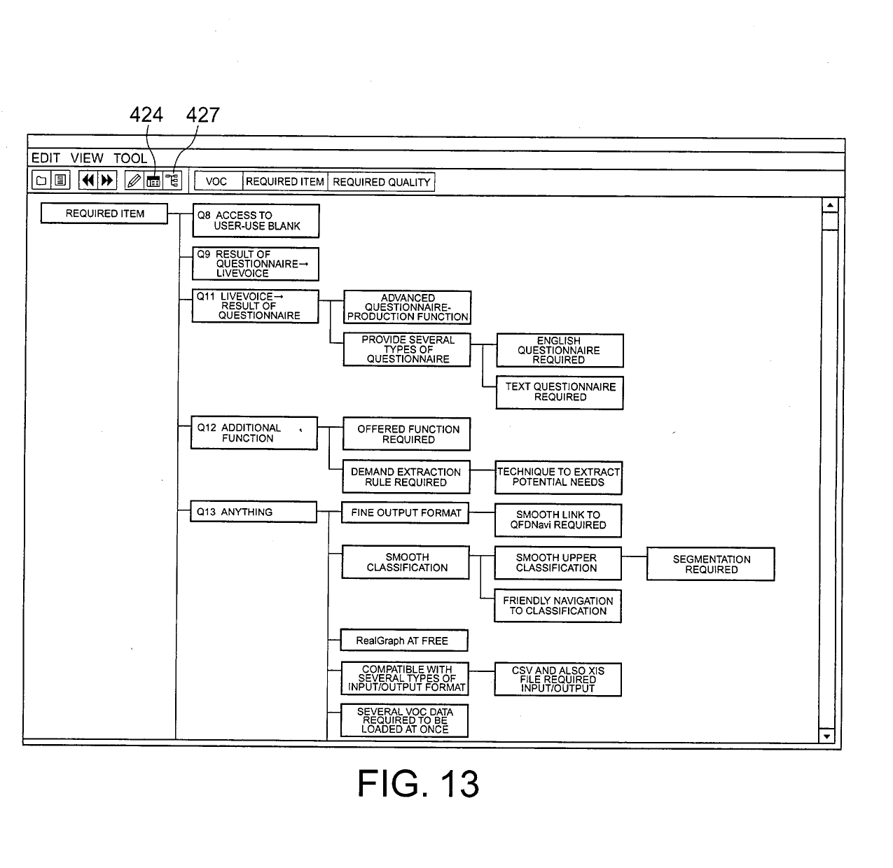

Illustrated in FIGS. 12 and 13 is view selection between two types of window format. FIG. 12 shows a table screen for displaying a list of items according to hierarchy. FIG. 13 shows a tree diagram screen for displaying a graph of tree diagram.

The table screen and the tree diagram screen are switched by a single action of clicking a table-screen window icon 424 or a tree-diagram-screen window icon 427, shown in FIGS. 9 and 10.

Accordingly, not only the table screen but also the tree diagram screen for displaying a graph of tree diagram offer quick check of specific data structures in the results of classification or the total structure.

Not only one result of classification but also several results of classification may be offered to several items. The results of classification may be displayed at the same time or alternately. This modification can be applied for several purposes. For example, if item attributes include age group or gender for persons who have ideas, a result of classification according to age group and that according to gender are compared with each other for check of change in trend of voices.

[8-6. Production of Questionnaire]

The external command “produce questionnaire” under the selection of the tool “execute external application” via the tool icon 413 creates questions from work data for producing a certain form at of questionnaires. The user task is specifying data requirements for questions, such as, “groups at the highest level of hierarchy in required quality are subjected to comparison in questionnaires”.

The external command “produce questionnaire” thus automatically produces work-data reflected questionnaires, with a single user task, the selection of this command only without operations such as selection of questions.

[9. Advantages]

The idea-drawing support procedure in this embodiment disclosed above has the following advantages:

The idea-drawing support procedure in this embodiment allows the user to draw next-level ideas from certain-level ideas while checking the certain-level ideas such as VOCs and required items on screen and then classify the next-level ideas while checking these next-level ideas on screen.

In addition to the classification of the next-level ideas, the user is further allowed to classify the original ideas, the source of the next-level ideas, into groups. Therefore, the embodiment achieves less unfruitful operations such as drawing the same ideas and for high idea-drawing operation efficiency. Moreover, the classification of the original ideas, the source of the next-level ideas, helps the user grasp the trend of entire ideas.

The user is allowed to display the contents of several groups on several item windows in the classification window, for on-screen operations using character strings of ideas, etc., while checking the contents of several groups at the same time. Thus, the embodiment offers highly efficient user-initiative idea classification procedure.

In addition, the embodiment offers highly efficient next-level-idea drawing procedure based on former-level ideas and their attribute information. Further accurate and efficient idea drawing procedure is achieved using the scene information, such as, person's (customer's) attribute, attribute on the situation of opinion (complaints) and attribute on the background of opinion (complaints) and requirements. The user is allowed to edit the scene information or replace the information with other scene information. Thus, the embodiment offers flexible idea drawing procedure in accordance with change in scene information.

In storage of extracted and classified data, attribute information, such as, time of storage and the names of data-creation and -modification operators are automatically stored with the data. The stored attribute information helps the user easily check the history as to who and when edit the data in combining work files created by several operators.

The idea-drawing support procedure in this embodiment helps the user effectively extract required items and qualities from VOCs and further draw quality characteristics, solutions, etc., from the required items. Therefore, the embodiment offers the user a variety of VOC-reflected data.

The embodiment has the function of automatic creation of candidates of next-level item in this embodiment. The task for the user in entering the candidates is just selection of the automatically created candidates with no necessity of entering sentences of drawn ideas one by one. Thus, the embodiment offers the user-friendly idea drawing operation.

In addition, the user is allowed to select any automatically created candidate as the next-level idea with no modification to create ideas. This function achieves the user-friendly automatic idea creation operation in which the user task is just candidate selection among automatically created candidates.

In idea classification, the user is allowed to open the next-level item window and detailed-information window to list up information related to original ideas, the source of extraction of next-level items. This function offers efficient idea classification.

The contents of several groups are displayed on several item windows while the group hierarchy is displayed on a group window, at the same time.

This simultaneous displaying function allows the user efficient data classification according to needs while simultaneously checking the contents of several groups and the group hierarchy. This function offers user-friendly operations such as change in groups to which items or subgroups belong only by shifting the items or the subgroups over several item windows.

Moreover, the displayed contents in or after shifting of items or groups directly indicate change in groups to which items or subgroups belong or the contents of changed groups. This function allows the user to visually check the operation or the contents of each group at present. Thus, the user can easily check the advancements in classification and decide the next operation. This function therefore offers efficient user-initiative classification.

Furthermore, groups can be “opened” or “closed” in item windows according to group appointments or release. Thus, the user can “open” any groups to check the contents according to needs. In addition, the user is allowed to “close” the groups already checked or processed or useless groups, in other words, “open” the needed groups only for efficient classification.

Moreover, new groups can be automatically created with item drag-and-drop operations over several item windows only, thus this function offering user-friendly operations.

Furthermore, the relationships between groups can be automatically modified with group drag-and-drop operations within the group window only, thus this function offering user-friendly operations. In addition, operations to groups in the group window allow the user to change the status of item windows and the displayed contents.

The user is allowed to “open” any group not only by selecting the group in the group window but also dragging it in the group window and dropping it into an item window. In particular, the user is allowed to “open” a group in any item window displayed on a designated location on screen by selecting a group destination. This function thus offers efficient classification with appropriate selection of a display location. In addition, a single operation of “closing” an already “opened” group and “opening” a new group achieves high efficiency.

A new group can be “opened” in one of item windows (all opened) without the user tasks of selecting this window or closing the other item windows, for enhanced operability.

In detail, it is automatically determined whether the number of item windows has reached the maximum window number. If negative, the number of item windows is increased and a new group is “opened” in one of the new item windows. In contrast, if positive, a group of the least priority in use is automatically “closed” and a new group is “opened” in place of the “closed” group.

The user task for changing the number of item windows to be displayed is just the number settings. This function allows the user to display the optimum number and size of item windows according to needs, such as, displaying the contents of groups in a large window if needed groups are few, thus achieving high classification efficiency.

In reviewing and classification of data per level of VOC, required item and required quality, all groups in each level can be simultaneously “opened” by specifying the levels one by one without selecting each group, thus this function achieving high efficiency.

The classification window can be switched to the table screen for listing up work data any time to check the advancements of operations. Data made active by the user on the table screen can be automatically active on the classification window switched from the table screen with no user operations for further classification operation.

Not only the table screen, but also the tree-diagram screen is offered for displaying a tree diagraph showing the results of extraction and classification. Thus, the user can easily grasp the data structure of target portions or entire structure in the results of extraction and classification.

The results of extraction and classification can be switched and displayed over several items for comparative review from several points of view.

The commands “classify by attribute” for automatic classification according to attributes and “classify by keyword” for automatic classification according to keywords achieve high classification efficiency.

The user task for automatic classification in succession to the results of classification at the prior level is just selection of the command “prior group succeed”. This automatic classification function requires no classification per level, thus enhancing efficiency.

In addition, the user task for automatic classification in accordance with abstractiveness decided by the type or the number of part of speech is just selection of the command “classify by part of speech”, thus achieving high classification efficiency.

Automatic merger of several classification results obtained through different operations offers high operational efficiency, especially, in merger of a huge number of classified data. This function thus allows the user to effectively utilize several types of classified data.

Moreover, the user is offered the function of automatic production of questionnaires. The user task for this function is just selecting the external command “produce questionnaire” at the completion of idea drawing and classification, with no operations such as selection of questions while checking work data.

[10. Other Embodiments]

Not only the embodiment disclosed above, but also several different types of embodiments are feasible under the scope of the present invention.

For example, the procedure of required-quality extraction disclosed so far is that required items are extracted from VOC and then required quality is extracted from the required items. Not only that, several types of procedure are available such as direct extraction of required quality from VOC, with the single requirement that ideas be drawn at different levels.

Moreover, required items may be developed into quality characteristics or solutions, with the data structure of several generations of parent-child relationship among parents, children, grandchildren, great-grandchildren, etc, in addition to two-generation data on parents and children.

Furthermore, disclosed so far is idea classification in parent-idea and child-idea trees under the parent-child relationship. Not only that, child-idea and grand child-idea trees can be constructed with no parents, which allows the user to enter any required items and qualities irrespective of VOCs, the source of extraction.

The embodiment disclosed above requires a VOC-data file to be loaded. Not only that, VOCs can be automatically loaded based on header information attached to the results of questionnaires, with no such VOC-data files.

An idea-drawing support program according to the present invention can share specific-format data with other several types of application programs. In detail, the program in this present invention can load data processed by another program for classification and then return the classified data to the other program. In addition, data processed by the program in this present invention can be sent to other programs for other data processing. Moreover, the idea-drawing support program according to the present invention can work with a QFD (Qualification Function Developments) support tool for further effective use of data gained under the present invention.

The procedures shown in FIGS. 1, 9A, 9B and 11 are just examples in this invention. In other words, the procedures can be modified, as long as, capable of giving the same supports to the user in classification procedure.

The relationships among mouse manipulations such as drag-and-drops and double-clicks, the corresponding actions on screen and the resultant data contents disclosed above are just examples. For example, the double-click operation can be changed to a single-click operation. In other words, these relationships can be modified in accordance with procedures, classification window, data to be processed, operation modes, etc.

Moreover, the window formats for the classification window, the result-view window, etc., are selectable. For example, several item windows may only be displayed as the classification window while the group window in closed for simple grouping with no hierarchy. In addition, displaying and modifications to group hierarchy are achieved by, for example, “opening” groups in different levels of hierarchy and dragging and dropping the groups over several opened windows without opening the group window.

Not only VOCs and demands drawn from the VOCs, the present invention is also feasible to drawing different level of ideas from several sentences having a variety of meanings.

In addition, classified data under the present invention may be output in several formats such as files that match the displays on windows.

As disclosed above in detail, the present invention provides computer-aided idea-drawing support method and a program product for supporting idea drawing that offer the user efficient idea drawing and classification operations for demands from. VOCs, for example, on the idea-classification-support classification window for displaying the contents of several groups and on idea-drawing-support windows, for effective data usages.

It is further understood by those skilled in the art that the foregoing description is a preferred embodiment of the disclosed device and that various change and modification may be made in the invention without departing from the spirit and scope thereof.

What is claimed is:

1. A computer-aided idea-drawing support method comprising:
supporting drawing different levels of ideas from at least one idea at a level of source of drawing on a drawing window displaying the idea;
supporting classification of the ideas into groups on a classification window displaying the drawn ideas, contents-view windows for displaying a list of elements per group with element character strings each expressing one of the elements constituting each group being openable on the classification window; and
storing at least one result of the idea drawing and classification.

2. The idea-drawing support method according to claim 1, wherein the drawing window displays the idea at the level of source of drawing and attribute information added to the idea.

3. The idea-drawing support method according to claim 2, wherein the drawing supporting step includes supporting edition of the attribute information displayed on the drawing window or replacing the attribute information with another attribute information.

4. The idea-drawing support method according to claim 2, wherein the result storing step includes storing information on time and on at least one operator who has conducted the idea drawing and/or the idea classification as a part of the attribute information.

5. The idea-drawing support method according to claim 1, wherein the drawing supporting step includes:
creating input candidates for the different levels of ideas drawn from the idea at the level of source of drawing; and
displaying the created candidates on the drawing window to support selection of one of the candidates.

6. The idea-drawing support method according to claim 5, wherein the candidate creating step includes at least one of creating the candidates by dividing the idea at the level of source of drawing into pieces, creating the candidates based on input history, and creating the candidates by searching for character strings specified from already created ideas.

7. The idea-drawing support method according to claim 5, wherein the drawing supporting step includes deciding at least one of the created input candidates as one of the ideas at the levels different from the level of source of drawing when automatic idea creation is selected.

8. The idea-drawing support method according to claim 1, wherein the classification supporting step includes displaying information on the idea at the level of source of drawing a next-level idea when the next-level idea is designated on the classification window.

9. The idea-drawing support method according to claim 1, wherein the classification supporting step includes supporting classification of ideas at the level of source of drawing.

10. The idea-drawing support method according to claim 1, wherein the classification supporting step includes deciding a group to which an element belongs according to where an element character string expressing an element selected from the list displayed on one of the contents-view windows is shifted.

11. The idea-drawing support method according to claim 10, wherein the classification supporting step includes:
opening one of the contents-view windows for displaying a list of elements of a designated group; and
deleting the list of elements of the designated group on the contents-view window when the designated group is released and closing the contents-view window, the group deciding step includes creating a new group corresponding to one of the contents-view windows to which an element character string expressing an element selected from a list displayed on another of the contents-view windows has been shifted and processing the element expressed by the shifted element character string as if the element has been shifted to the new group.

12. The idea-drawing support method according to claim 10, wherein a group window for displaying group hierarchy with group character strings each expressing a group is displayed on the classification window with the contents-view windows.

13. The idea-drawing support method according to claim 12, wherein the classification supporting step includes processing a certain group as if the certain group has been shifted to a hierarchy when a group character string expressing the certain group has been selected on the group window and shifted in the group window, the group processing step including a display-control step of opening or closing a certain one of the content-view windows or switching a display on the certain content-view window in accordance with an operation to at least one group character string displayed on the group window.

14. The idea-drawing support method according to claim 13, wherein the display-control step includes displaying a list of elements of another certain group on another certain one of the content-view windows, the other certain group being expressed by a group character string selected on the group window and shifted to the other certain content-view window, irrespective of whether the other certain content-view window is open or closed.

15. The idea-drawing support method according to claim 14, wherein the display-control step includes deleting a list of elements of a group of lowest priority in use among groups displayed on the contents-view windows which are all open when a group is designated and displaying a list of elements of the designated group on one of the contents-view windows from which the list of elements of the group of lowest priority in use has been deleted.

16. The idea-drawing support method according to claim 1, wherein the classification supporting step includes:
displaying a predetermined number of content-view windows;
changing the predetermined number when a particular number of content-view windows is designated; and
displaying the predetermined number of content-view windows.

17. The idea-drawing support method according to claim 1, wherein the classification supporting step includes displaying a plurality of lists of elements of groups at a designated idea level over the content-view windows at once.

18. The idea-drawing support method according to claim 1 further comprising switching the classification window and a table screen for displaying data, in which a particular information made active on the table screen is further made active on the classification window when the table screen is switched to the classification window.

19. The idea-drawing support method according to claim 1 further comprising opening a result-view window for displaying the stored result of idea drawing and classification, the result-view window opening step including opening a tree-diagram screen for displaying a tree diagram of the result as a graph.

20. The idea-drawing support method according to claim 1, wherein the classification supporting step includes classifying ideas in accordance with designated attribute information added to the ideas to be classified.

21. The idea-drawing support method according to claim 1, wherein the classification supporting step includes classifying ideas in accordance with keywords as to whether the ideas to be classified involve at least any one of the keywords that are parts of speech extracted from the ideas in order of frequency of appearance in the ideas.

22. The idea-drawing support method according to claim 1, wherein the classification supporting step includes classifying ideas in which a result of classification at a prior level is succeeded to classification of the ideas at a current level.

23. The idea-drawing support method according to claim 1, wherein the classification supporting step includes classifying the ideas into hierarchy levels in accordance with abstractiveness of parts of speech in the ideas.

24. The idea-drawing support method according to claim 1, wherein the classification supporting step includes converting several results of the idea drawing and classification into a format of a particular result of the idea drawing and classification to consolidate the several results and the particular result.

25. The idea-drawing support method according to claim 1, wherein the classification supporting step includes consolidating first portions of each of hierarchy levels, groups and data, when the first portions are identical to one another whereas creating new groups for second portions of each of hierarchy levels, groups and data, when the second portions are not identical to one another, over a plurality of results of the idea drawing and classification, thus consolidating results of the idea drawing and classification on the first and second portions.

26. The idea-drawing support method according to claim 1 further comprising creating questions for questionnaires based on the stored result of the idea drawing and classification.

27. The idea-drawing support method according to claim 1, wherein the extraction supporting step includes supporting extraction of demands from persons' opinions and the classification supporting step includes supporting classification of the extracted demands.

28. The idea-drawing support method according to claim 27, wherein attribute information is added to the persons' opinions, selected from attribute of each person, attribute of a situation of giving opinions and attribute of circumstances or requirements connected to opinions.

29. The idea-drawing support method according to claim 1, wherein the extraction supporting step includes supporting extraction of required items from the persons' opinions and supporting selective extraction among required qualities, quality characteristics and solutions from the extracted required items.

30. A computer-readable program product for supporting idea drawing comprising:
a function of supporting drawing different levels of ideas from at least one idea at a level of source of drawing on a drawing window displaying the idea;
a function of supporting classification of the ideas into groups on a classification window displaying the drawn ideas, contents-view windows for displaying a list of elements per group with element character strings each expressing one of the elements constituting each group being openable on the classification window; and
a function of storing at least one result of the idea drawing and classification.

31. The computer-readable program product according to claim 30, wherein the extraction supporting function includes a function of supporting extraction of demands from persons' opinions and the classification supporting function includes a function of supporting classification of the extracted demands.
